(19) United States
(12) Patent Application Publication
(10) Pub. No.: US 2018/0294567 A1
(43) Pub. Date: Oct. 11, 2018

(54) Patch antenna system with parasitic edge-aligned elements

(71) Applicant: The Charles Stark Draper Laboratory, Inc., Cambridge, MA (US)

(72) Inventors: Jonathan Michael O'Brien, Tampa, FL (US); Phillip Bradford Hulse, Tampa, FL (US); Dorothy Carol Poppe, Saugus, MA (US)

(21) Appl. No.: 15/481,116

(22) Filed: Apr. 6, 2017

(51) Int. Cl. H01Q 9/04; H01Q 13/20; H01Q 13/10; H01Q 19/00; H01Q 9/06; H01Q 21/24; H01Q 21/06

(52) U.S. Cl. CPC H01Q 9/0407; H01Q 13/206; H01Q 13/106; H01Q 21/065; H01Q 9/065; H01Q 21/24; H01Q 19/005

(57) ABSTRACT

A patch antenna system comprises a patch antenna and preferably two sets of strip-shaped parasitic elements arranged over the radiating edges of the patch antenna. The parasitic elements are spaced away from the patch antenna. Preferably, the material placed between the patch antenna and parasitic elements is selectively deposited to introduce an air gap between the elements and the antenna while also introducing mechanical support for the elements. This selective deposition of material also relaxes the requirements for high radio frequency (RF) performance, thereby reducing cost. One advantage of this solution is that it enables circular polarization to be achieved.

### BACKGROUND OF THE INVENTION

A microstrip or patch antenna is a low-profile antenna. In its simplest example, it is a rectangular, half wavelength long conductive plate separated from a ground plane by a dielectric substrate. These antennas can be manufactured, easily often using printed circuit board technology.

Many times, patch antennas are integrated into two-dimensional arrays. By controlling the phasing between the antennas of the array, directional antennas can be created, such as antennas with pencil beams, fan beams and omni-directional coverage beams. Further the antennas can be designed to provide linear or circular polarization. Often the arrays are planar, but they can be curved depending on the application and structure in which they are implemented.

Historically, published design curves on rectangular patch antennas show a distinct correlation between substrate parameters, such as thickness and relative permittivity, and radiation characteristics of the antennas. More specifically, broadside gain (i.e., gain in the direction orthogonal to the plane of the antenna) is increased when the substrate permittivity is reduced; and the achieved fractional bandwidth (FBW=BW_{3 dB}/f_{c}, where BW_{3 dB} is the frequency range over which the gain is at least half the peak gain, and f_{c} is the center frequency of the device) of the patch antenna is increased when the substrate thickness is increased. Lower limitations on substrate permittivity is set at 1, being that of air, and substrate thickness is restricted below a height where destructive surface waves appear as well as cancellation in the phase front of the far fields. A thoughtfully designed rectangular patch antenna can achieve a peak broadside gain of 8 decibels (dB) with a fractional bandwidth of 10%. Typically, improvements in the fractional bandwidth involve complex multilayer bent patches and suffer from a reduction in gain.

In the past, parasitic elements have been used to improve gain and fractional bandwidth of patch antennas. Previous designs have generally used large rectangular parasitic elements spaced with a dielectric layer to modify the gain and/or fractional bandwidth of the antenna. Other parasitic elements have been placed in the plane of the patch antenna.

### SUMMARY OF THE INVENTION

The present invention can be used to improve the broadside gain and fractional bandwidth of patch antennas compared to typical rectangular, polarized (e.g., circular), patch antenna designs. By integrating one or more parasitic elements above the radiating edges of a patch antenna, the broadside gain can be improved by as much as 1 dB or more. Moreover, the fractional bandwidth can be increased to as much as 25%, or more.

These improvements are accomplished by carefully designing the parasitic elements and the patch antenna. Specifically, the set of parasitic elements is designed to resonate slightly away from the resonance of the patch antenna. The parasitic elements are spaced from the patch antenna such that intentional coupling occurs between the patch antenna and the parasitic elements. This coupling increases the impedance bandwidth seen at the feed of the antenna which correspondingly provides the improvements in realized broadside gain and fractional bandwidth. The set of parasitic elements can also be designed to control polarization. To achieve circular polarization, for example, the set of parasitic elements includes a pair of parasitic elements for each of the orthogonal modes of the patch antenna system. The elements are arranged to avoid coupling in either a direct or capacitive fashion between these pairs of parasitic elements, preferably by separating and/or isolating the pairs of parasitic elements from each other. In one example, this isolation is realized by separating the orthogonal mode parasitic elements by a dielectric layer.

The parasitic elements are spaced away from the patch antenna using a material deposited between the elements and the antenna. The dielectric constant of this material should be as close to air as possible. Preferably, the material placed between the patch antenna and parasitic elements is selectively deposited to introduce an air gap between the elements and the antenna while also introducing mechanical support for the elements. This selective deposition of material also relaxes the requirements for high radio frequency (RF) performance, thereby also reducing cost.

It further provides a path to integrate air gaps between the patch antenna and parasitic elements while maintaining structural integrity. These air gaps allow the achieved gain and bandwidth improvements brought about by the parasitic elements to be maintained.

In general, according to one aspect, the invention features a patch antenna system. It comprises a patch antenna and at least one strip-shaped parasitic element arranged over a radiating edge of the patch antenna.

In the current embodiment, the patch antenna is rectangular and is located in a well and the at least one parasitic element is supported on a membrane layer extending over the well.

Further, the at least one strip-shaped parasitic element preferably comprises a first polarization right parasitic element and a first polarization left parasitic element, each arranged over an opposite radiating edge of the patch antenna. The strip-shaped parasitic elements can further comprise a second polarization right parasitic element and a second polarization left parasitic element that are arranged over other opposed radiating edges of the patch antenna.

The different polarization parasitic elements should be separated from each other by a dielectric membrane layer, for example.

In general, according to another aspect, the invention features an antenna system. The system comprises an antenna, such as a patch or loop antenna, and two pairs of parasitic elements arranged over the antenna.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective scale view of a patch antenna system according to the present invention;

FIG. 2 is a perspective cross sectional view of the patch antenna system;

FIGS. 3A and 3B are plan views showing the horizontal polarization parasitic elements and the vertical polarization parasitic elements, respectively of the patch antenna system;

FIG. 4 shows the patch antenna system integrated into a patch array;

FIG. 5 is a plot of broadside gain in decibels (dB) as a function of normalized frequency for an exemplary patch antenna system employing the present invention (solid line) compared to a conventional patch antenna (dotted line); and

FIG. 6 is a plot of return loss in decibels as a function of normalized frequency for the inventive patch antenna system (solid line) compared to a conventional patch antenna (dotted line).

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

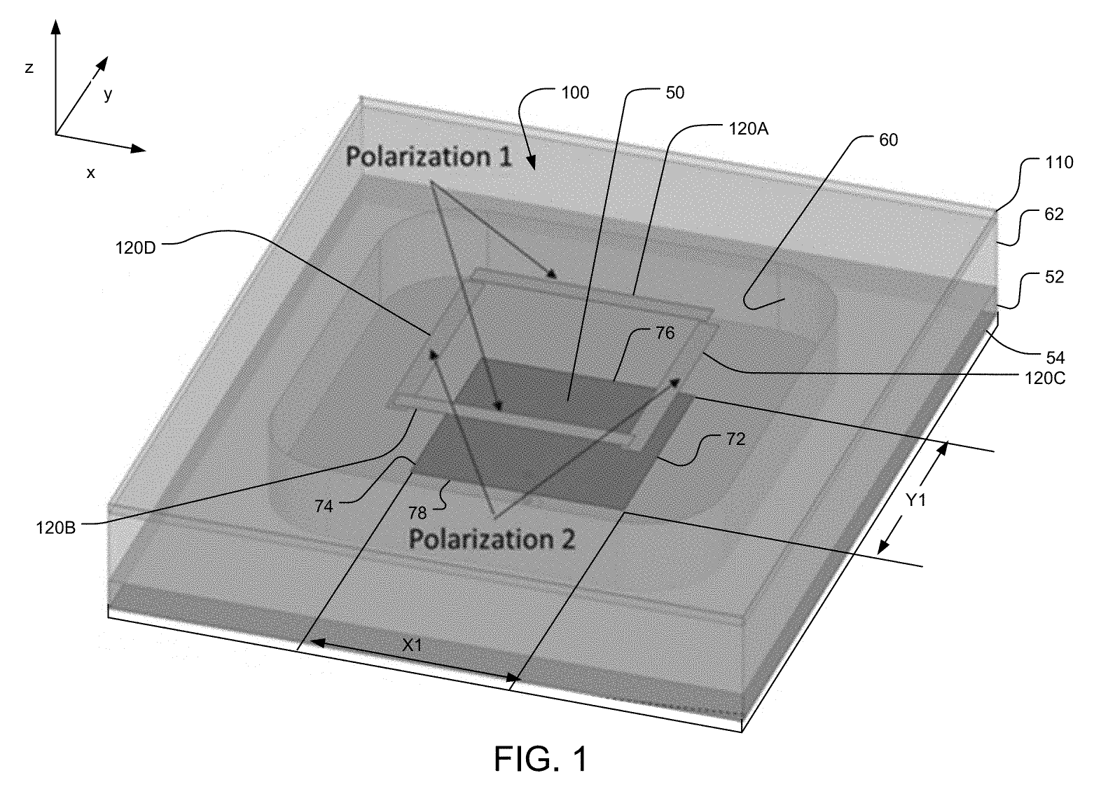

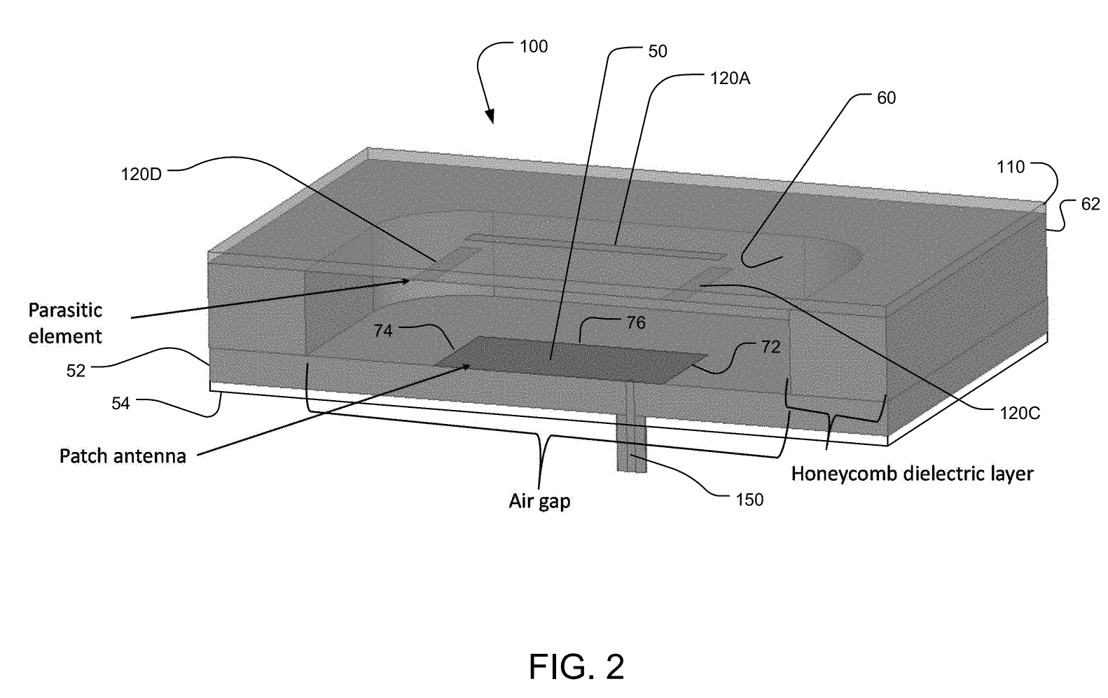

FIGS. 1 and 2 illustrate a patch antenna system 100 that is been constructed according to the principles of the present invention.

In general, patch antenna system 100 comprises a patch antenna 50 and one or more, preferably two pairs of, strip-shaped parasitic elements 120 arranged over the radiating edges of the patch antenna 50. The patch antenna 50 is excited or the incoming RF signal detected via feedline 150 (see FIG. 2).

In more detail, in the illustrated embodiment, the patch antenna 50 is deposited on a topside of a planar substrate 52. Often, the patch antenna 50 is a metal layer or patterned metallization, such as copper, that has been deposited upon the topside of the substrate layer 52. The bottom side of the substrate layer 52 has been metallized or rendered conductive to provide a ground plane 54.

The substrate layer 52 should be a dielectric material such as: Rogers RT/Duroid 6002. It should have a permittivity of at least 1. Generally, its thickness in the z-axis direction is about λ_{g}/14.

The patch antenna 50 is located in a well 60. Specifically, a dielectric frame layer 62 projects orthogonally from the substrate 52, in the z-axis direction, and surrounds the perimeter of the patch antenna 50. Typically, the inner sides of the well 60 are spaced in the x-axis and y-axis directions, from the four radiating edges 72, 74, 76, and 78 of the patch antenna 50, by a distance that is at least half the length X1 of the patch antenna along the x axis and the width Y1 along the Y axis.

The dielectric frame layer 62 is preferably fabricated using selective deposition. Example materials for this layer include Teflon, Rohacell, Polycarbonate. Moreover, the frame layer 62 is preferably deposited to include airgaps such as in a honeycomb pattern. This provides a method to introduce mechanical support while minimizing the RF impact and therefore maintain the gain and bandwidth improvements brought about by the parasitic elements 120.

A dielectric membrane layer 110 is attached to or deposited on the top of the dielectric frame layer 62. This dielectric membrane layer 110 preferably extends over the well 60 and extends parallel to the plane of the patch antenna 50 but spaced away by the thickness of the frame layer 62. In this example the thickness of the frame layer 62 in the z-axis direction and thus the spacing between the patch antenna 50 and parasitic elements 120 is set at λ/9 (where λ is the wavelength of the intended operating center frequency for the patch antenna system) with the dielectric medium being air.

The dielectric membrane layer 110 carries at least one parasitic element. Preferably, the dielectric membrane layer 110 carries two sets of parasitic elements.

The shape and orientation of these one or more parasitic elements 120 is important. Preferably, the parasitic elements 120 are strip-shaped. Moreover, they are each disposed above a different radiating edge 72, 74, 76, 78 of the patch antenna 50. Preferably, the parasitic elements have a length that corresponds to the length of the corresponding radiating edge 72, 74, 76, 78. In the illustrated embodiment, these lengths are indicated by either references X1 or Y1.

The length and width of the patch antenna 50 and the lengths of the parasitic elements 120 are dictated by the intended operational frequency/wavelength of the patch antenna system 100, as well as the thickness and permittivity of the dielectric substrate 52. The parasitic elements 120 are designed to be slightly greater than or less than half of a wavelength in length while the length and width of the patch antenna are set at half a wavelength, as to separate the two resonances slightly.

On the other hand, the parasitic elements are relatively narrow in their width. In the preferred embodiment, their aspect ratio, length to width, is at least 10 to 1.

The illustrated embodiment also concerns a patch antenna system 100 that produces/receives circularly polarized radiation. In this mode of operation, the parasitic elements 120 comprise a first polarization (e.g., horizontal polarization) right parasitic element 120A and a horizontal polarization left parasitic element 120B. This set of first or horizontal polarization parasitic elements 120A, 120B are aligned parallel to the opposite radiating edges 76, 78 of the patch antenna 50.

Similarly, parasitic elements 120 further comprise a second polarization (e.g., vertical polarization) right parasitic element 120C and a vertical polarization left parasitic element 120D. This set of second or vertical polarization parasitic elements 120C, 120D are aligned parallel to the two other radiating edges 72, 74, respectively, of the patch antenna 50.

The best performance (e.g. increase in broadside gain and/or fractional bandwidth) is obtained when the parasitic elements 120A, 120B, 120C, 120D are isolated and separated from each other. In the illustrated embodiment, this is achieved by depositing or otherwise forming the vertical polarization parasitic elements 120C, 120D on the bottom side of the dielectric membrane layer 110 and depositing or otherwise forming the horizontal polarization parasitic elements 120A, 120B on the top side of the dielectric membrane layer 110.

In the preferred embodiment, the strip-shaped parasitic elements 120A, 120B, 120C, 120D are directly vertically aligned over their respective radiating edges 76, 78, 72, 74, respectively, of the patch antenna 50. Specifically, in each example, when the respective radiating edge is projected in the z-axis direction, it passes-through, laterally bisects, the corresponding parasitic element.

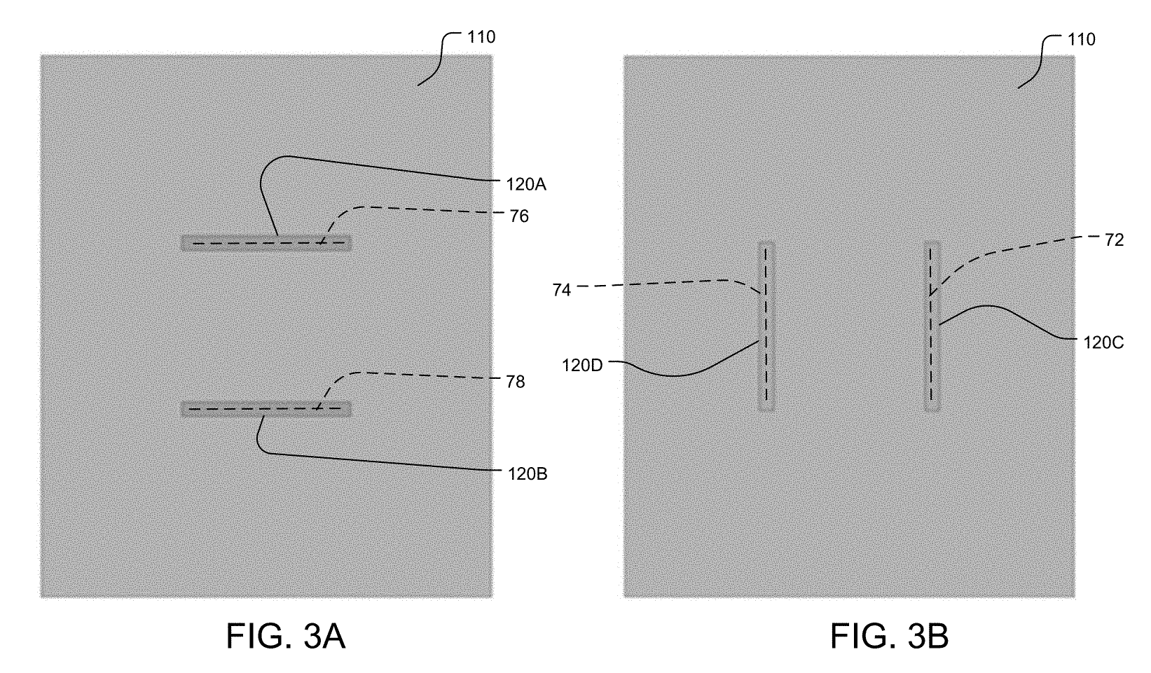

FIG. 3A illustrates the first/horizontal polarization parasitic elements 120A, 120 B on the dielectric membrane layer 110. Also shown is the extent of the corresponding radiating edges 76, 78 of the underlying patch antenna 50.

FIG. 3B illustrates the second/vertical polarization parasitic elements 120C, 120D on the dielectric membrane layer 110. Also shown is the extent of the corresponding radiating edges 72, 74 of the underlying patch antenna 50.

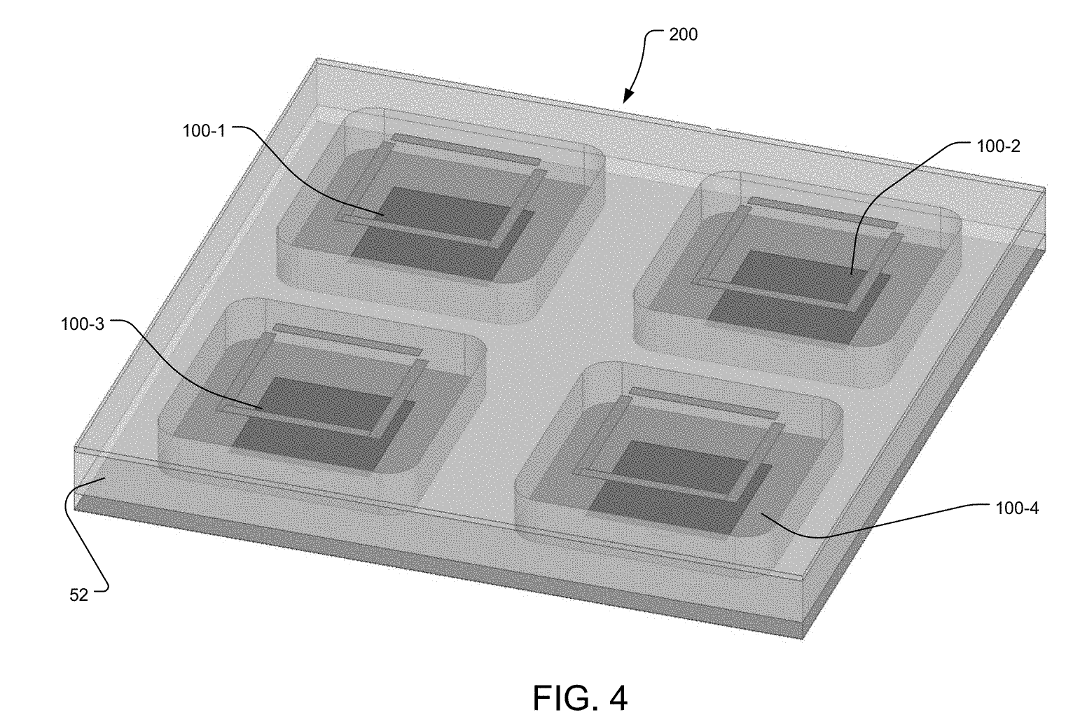

FIG. 4 shows the use of the patch antenna system 100 in a patch antenna array 200. Specifically, four patch antenna systems 100-1, 100-2, 100-3, and 100-4 are integrated together on a common substrate 52 to form a 2×2 array of patch antennas. By controlling the relative delay of the signal fed to the patch antennas 100 or controlling the delay of the signals received by the separate patch antennas 100, a directional patch antenna system is provided.

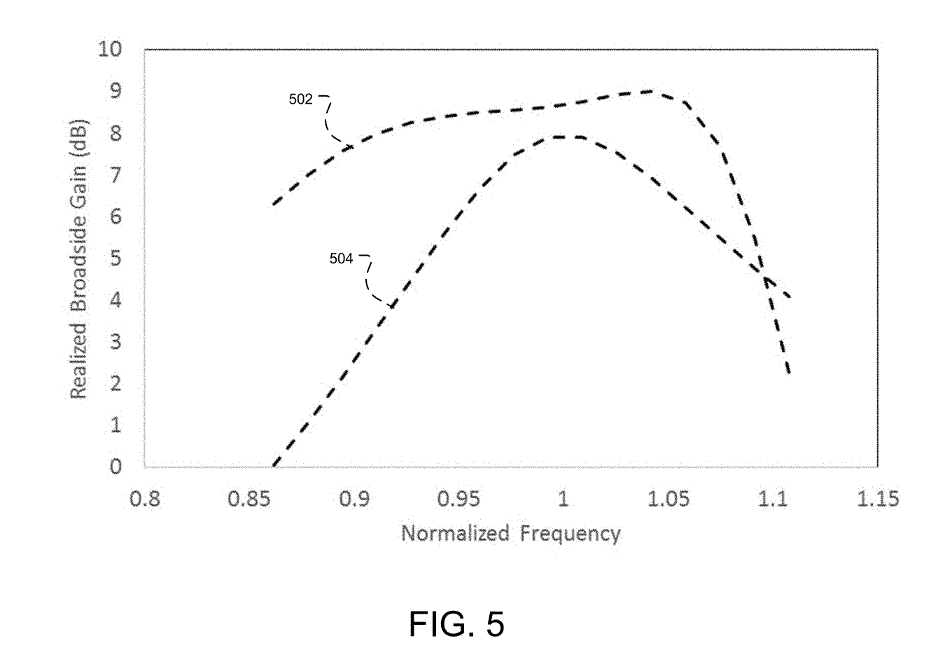

FIG. 5 shows the improved performance that can be achieved using the patch antenna system 100 of the present invention. Specifically, the broadside gain 502 provided by the patch antenna system 100 is greater than the broadside gain 504 of a conventional patch antenna such as a rectangular patch antenna and has a much wider bandwidth. In this example, the peak broadside gain is increased by 0.7 dB while the fractional bandwidth at the 3 dB half power point is also increased from 11% to 25%.

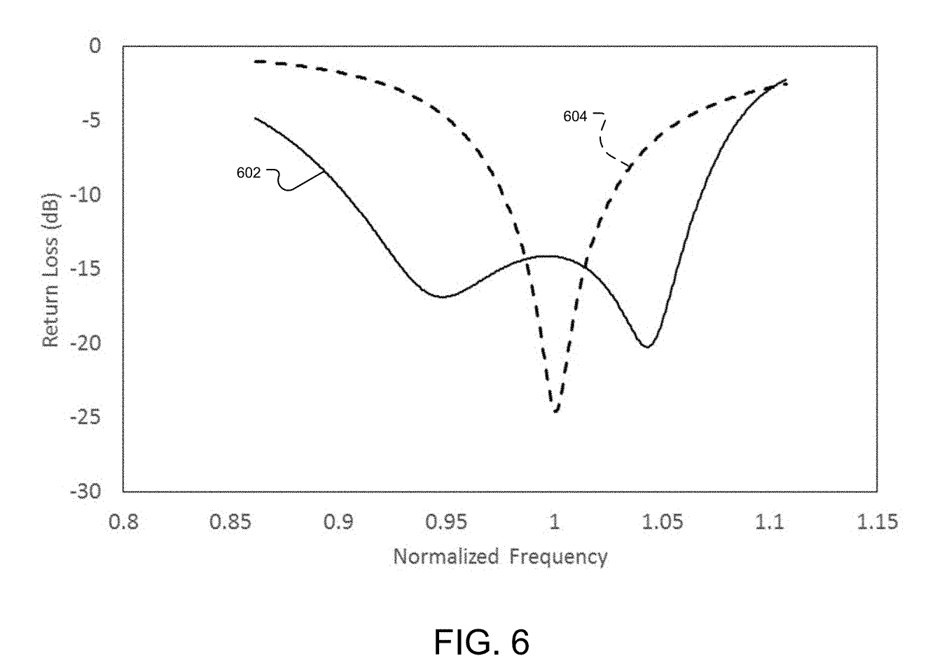

FIG. 6 shows the lower signal return loss 602 provided by the inventive patch antenna system 100 compared to that of a conventional patch antenna such as a rectangular patch antenna, indicated by reference 604. This return loss is simulated at the feed of the antenna system 100 demonstrating the increase in impedance bandwidth to justify the change in realized gain and fractional bandwidth.

In other embodiments, the described parasitic elements are integrated with different styles of antennas, such as a loop antenna. Furthermore, dual band antenna designs could implement multiple layers of parasitic elements, each spaced and sized properly, to improve the gain and bandwidth of the dual band radiating structure.

While this invention has been particularly shown and described with references to preferred embodiments thereof, it will be understood by those skilled in the art that various changes in form and details may be made therein without departing from the scope of the invention encompassed by the appended claims.

What is claimed is:

1. A patch antenna system, comprising:
a patch antenna; and
at least one strip-shaped parasitic element arranged over a radiating edge of the patch antenna.

2. The patch antenna system according to claim 1, wherein the patch antenna is located in a well and the at least one parasitic element is supported on a membrane layer extending over the well.

3. The patch antenna system according to claim 2, wherein the well is formed in a dielectric frame layer.

4. The patch antenna system according to claim 3, wherein the frame layer is fabricated using selective deposition.

5. The patch antenna system according to claim 3, wherein the frame layer is in the form of a honeycomb pattern.

6. The patch antenna system according to claim 1, wherein the patch antenna is rectangular.

7. The patch antenna system according to claim 1, wherein the at least one strip-shaped parasitic element comprises a first polarization right parasitic element and a first polarization left parasitic element, each arranged over an opposite radiating edge of the patch antenna.

8. The patch antenna system according to claim 7, wherein the strip-shaped parasitic elements further comprise a second polarization right parasitic element and a second polarization left parasitic element that are arranged over other opposed radiating edges of the patch antenna.

9. The patch antenna system according to claim 1, further comprising one or more first polarization parasitic elements and one or more second polarization parasitic elements.

10. The patch antenna system according to claim 9, wherein the first polarization parasitic elements and the second polarization parasitic elements are separated from each other by a dielectric membrane layer.

11. A antenna system, comprising:
an antenna; and
two pairs of parasitic elements arranged over the antenna.

12. The antenna system according to claim 11, wherein the antenna is located in a well and the two pairs of parasitic elements are supported on a membrane layer extending over the well.

13. The antenna system according to claim 11, wherein the antenna is rectangular.

14. The antenna system according to claim 11, wherein a first pair of parasitic elements comprises a first polarization right parasitic element and a first polarization left parasitic element, each arranged over an opposite radiating edge of the antenna.

15. The antenna system according to claim 14, wherein a second pair of parasitic elements comprise a second polarization right parasitic element and a second polarization left parasitic element that are arranged over other opposed radiating edges of the antenna.

16. The antenna system according to claim 11, wherein a first pair of the parasitic elements and a second pair of the parasitic elements are separated from each other by a dielectric membrane layer.

17. The antenna system according to claim 11, wherein the antenna is a patch antenna.

18. The antenna system according to claim 11, wherein the antenna is a loop antenna.

19. A patch antenna system, comprising:
a patch antenna;
a frame layer extending around the patch antenna;
a membrane layer on the frame layer, the membrane laser extending over the well; and
at least one strip-shaped parasitic element carried by the membrane layer over the the patch antenna.

20. The patch antenna system according to claim 19, wherein the patch antenna is located in a well formed in the frame layer.
